(19) United States
(12) Patent Application Publication
(10) Pub. No.: US 2023/0369808 A1
(43) Pub. Date: Nov. 16, 2023

(54) MECHANICAL SELF-LOCKING TYPE ANTI-FALLING SOCKET STRUCTURE

(71) Applicant: Jiangsu Barep intelligence Technology Co.,Ltd, Zhangjiagang (CN)

(72) Inventors: Jiangang Chen, Zhangjiagang (CN); Xiaobo Zheng, Zhangjiagang (CN)

(21) Appl. No.: 17/594,066

(22) PCT Filed: May 11, 2021
(86) PCT No.: PCT/CN2021/092976

§ 371 Date: Jul. 28, 2022

(30) Foreign Application Priority Data
Jan. 25, 2021 (CN) 202110094134.4

(51) Int. Cl. H01R 13/639; H01R 13/436

(52) U.S. Cl. CPC H01R 13/639; H01R 13/436

(57) ABSTRACT

The present disclosure discloses a mechanical self-locking type anti-falling socket structure, including a socket shell and several mechanical lock mechanisms. Several grooves and mechanical lock limiting slots are formed in the socket shell. A charging plugin is arranged in each groove. A charging jack is formed in the charging plugin. Each mechanical lock mechanism includes a pressure head and a lock body. The lock body outwards extends to be provided with a limiting convex slot. A limiting block is clamped in the limiting convex slot. The bottom of the lock body is provided with a spring slot. Two sides of the lock body are provided with sliding plates. The bottom of each mechanical lock limiting slot is provided with a spring. Two sides of the mechanical lock limiting slot are provided with sliding slots. The spring is clamped in the spring slot. The sliding plates are slidably connected into the sliding slots. In the present disclosure, the mechanical lock mechanisms are arranged in the socket shell; the limiting blocks are arranged on the lock bodies; the sliding blocks of the lock bodies move on the sliding slots, so that the lock bodies move forwards to enable the limiting blocks to resist against the plugs to prevent the plugs from falling, thus ensuring the connection between an electronic product and a power supply.

### TECHNICAL FIELD

The present disclosure belongs to the technical field of packaging devices, and in particular relates to a mechanical self-locking type anti-falling socket structure.

### BACKGROUND

With the development of science and technology, electronic products have been widely used in life. Therefore, plugs and sockets are indispensable connection devices between electronic products and power supplies. Plugs and sockets of various electronic products and electrical equipment also have different design ideas according to different usage requirements. Whether the plug and socket of the electronic product are connected safely and firmly is the basis for ensuring normal charging of the electronic product.

After most existing sockets have been used for a period of time, a clamping force between a jack in a socket body and a clamping clip becomes small, so that the plug easily falls off after being plugged, which affects the use of the socket.

### SUMMARY

In order to solve the problem that an existing plug easily falls off after being plugged into a socket, which affects the electrical connection between an electronic product and a power supply, the present disclosure aims to provide a mechanical self-locking type anti-falling socket structure.

In order to achieve the above purpose, the present disclosure uses the following technical solution. A mechanical self-locking type anti-falling socket structure includes a socket shell and several mechanical lock mechanisms. Several grooves and mechanical lock limiting slots are formed in the socket shell. A charging plugin is arranged in each groove. A charging jack is formed in the charging plugin. Each mechanical lock mechanism includes a pressure head and a lock body. The lock body outwards extends to be provided with a limiting convex slot. A limiting block is clamped in the limiting convex slot. The bottom of the lock body is provided with a spring slot. Two sides of the lock body are provided with sliding plates. The bottom of each mechanical lock limiting slot is provided with a spring. Two sides of a wall of the mechanical lock limiting slot are provided with sliding slots. The spring is clamped in the spring slot. The sliding plates are slidably connected into the sliding slots.

As a further description of the above-mentioned technical solution:

the limiting block is made of a rubber material.

As a further description of the above-mentioned technical solution:

the top of the pressure head is of a downwards bent arc shape.

As a further description of the above-mentioned technical solution:

several heat dissipation holes are formed in side walls of the grooves facing the outer side.

As a further description of the above-mentioned technical solution:

the bottom of the socket shell is provided with a positioning pillar.

As a further description of the above-mentioned technical solution:

the sliding plates are obliquely arranged on the two sides of the lock body, and the sliding slots are inclined.

As a further description of the above-mentioned technical solution:

the bottom of the limiting convex slot is provided with a clamping slot, and a rubber clamping plate is clamped in the clamping slot.

As a further description of the above-mentioned technical solution:

the height of the limiting block is greater than the height of the charging plugin.

As a further description of the above-mentioned technical solution:

the bottom of the mechanical lock limiting slot is provided with a cross bottom plate; the spring is fixedly connected to the cross bottom plate; and the bottom of the lock body resists against the cross bottom plate.

In summary, the above-mentioned technical solution is used, so that the present disclosure has the beneficial effects as follows.
1. In the present disclosure, the mechanical lock limiting slots and the grooves are formed in the socket shell; the charging plugins are arranged in the grooves; an accommodating space between the charging plugins and the grooves is used to accommodate plugs; the sliding slots are formed in the mechanical lock limiting slots; the sliding blocks on the lock bodies are slidably connected into the sliding slots; the bottoms of the lock bodies are provided with springs; and the lock bodies can move back and forth by pressing the pressure heads. When the pressure head is pressed, the lock body moves backwards to successfully unplug the plug. When the pressure head is released, the limiting block of the lock body resists against the plug to fix the plug and prevent it from falling, so that connection between an electronic product and a power supply is guaranteed.
2. In the present disclosure, the limiting block is made of the rubber material, so that it can be ensured that the exterior of the plug cannot be damaged by frequent clamping between the limiting block and the plug while a fixing and pretightening force is increased.
3. In the present disclosure, the top of the pressure head is of the downwards bent arc shape, so that this designed structure is matched with a pressing posture of a human hand, and the people's experience of usage is enhanced.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings based on these drawings without creative work.

FIG. 1 is a three-dimensional diagram I of a mechanical self-locking type anti-falling socket structure.

FIG. 2 is a three-dimensional diagram II of a mechanical self-locking type anti-falling socket structure.

FIG. 3 is an exploded diagram of a mechanical self-locking type anti-falling socket structure.

FIG. 4 is a detailed diagram of internal structures of a mechanical self-locking type anti-falling socket structure.

Illustrations in the drawings:

1: socket shell; 2: mechanical lock mechanism; 21: pressure head; 22: lock body; 3: groove; 4: mechanical lock limiting slot; 5: charging plugin; 6: charging jack; 7: limiting convex slot; 8: limiting block; 9: spring slot; 10: sliding plate; 11: spring; 12: sliding slot; 13: heat dissipation hole; 14: positioning pillar; 15: clamping slot; 16: rubber clamping plate; 17: cross bottom plate.

### DETAILED DESCRIPTION OF THE EMBODIMENTS

The technical solutions in the embodiments of the present invention will be clearly and completely described below in conjunction with the accompanying drawings in the embodiments of the present invention. Apparently, the described embodiments are only a part of the embodiments of the present invention, rather than all the embodiments. Based on the embodiments of the present disclosure, all other embodiments obtained by those of ordinary skill in the art without creative work shall fall within the protection scope of the present disclosure.

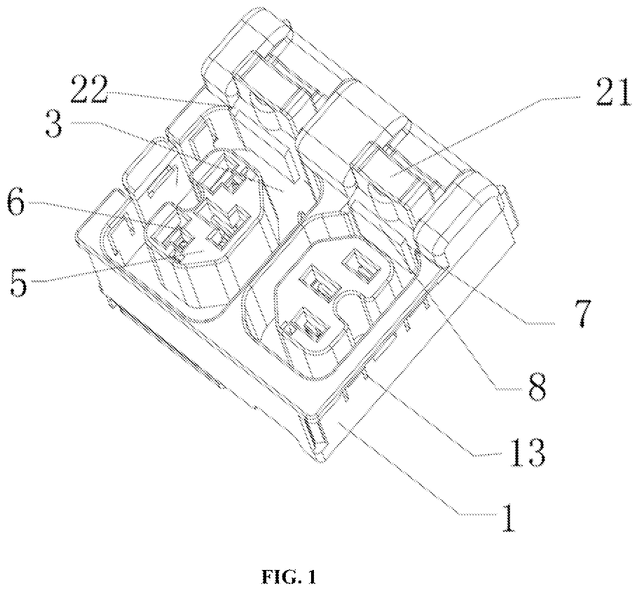

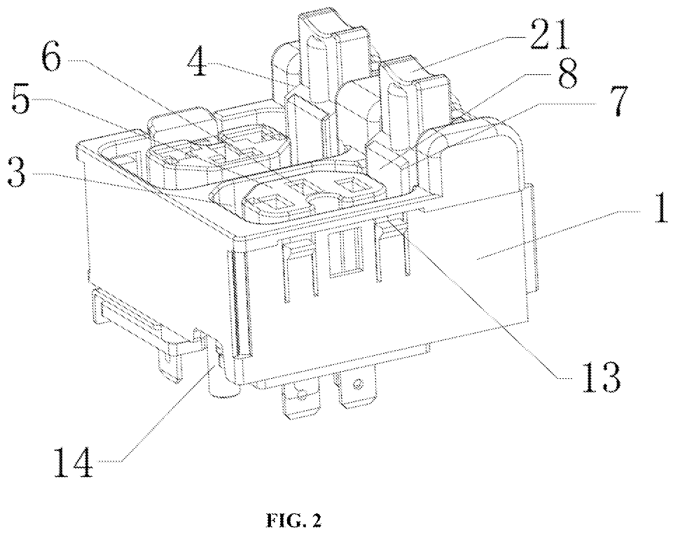

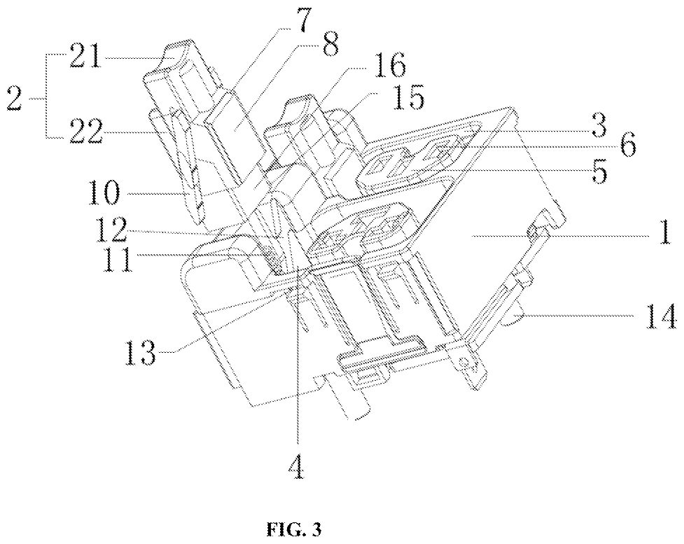

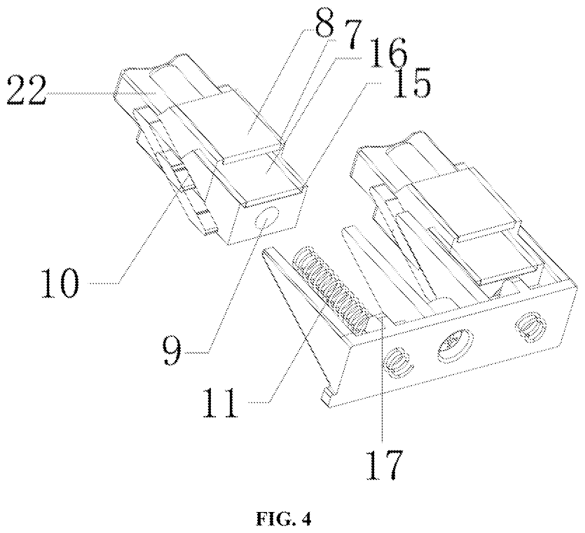

Referring to FIGS. 1-4, the present disclosure provides one technical solution: a mechanical self-locking type anti-falling socket structure, including a socket shell 1 and several mechanical lock mechanisms 2. Several grooves 3 and mechanical lock limiting slots 4 are formed in the socket shell 1. A charging plugin 5 is arranged in each groove 3. A charging jack 6 is formed in the charging plugin 5. Each mechanical lock mechanism 2 includes a pressure head 21 and a lock body 22. The lock body 22 outwards extends to be provided with a limiting convex slot 7. A limiting block 8 is clamped in the limiting convex slot 7. The bottom of the lock body 22 is provided with a spring slot 9. Two sides of the lock body 22 are provided with sliding plates 10. The bottom of each mechanical lock limiting slot 4 is provided with a spring 11. Two sides of a wall of the mechanical lock limiting slot 4 are provided with sliding slots 12. The spring 11 is clamped in the spring slot 9. The sliding plates 10 are slidably connected into the sliding slots 12. The mechanical lock limiting slots and the grooves are formed in the socket shell; the charging plugins are arranged in the grooves; an accommodating space between the charging plugins and the grooves is used to accommodate plugs; the sliding slots are formed in the mechanical lock limiting slots; the sliding blocks on the lock bodies are slidably connected into the sliding slots; the bottoms of the lock bodies are provided with springs; and the lock bodies can move back and forth by pressing the pressure heads. When the pressure head is pressed, the lock body moves backwards, and the limiting block releases fixing of the plug, so that the plug can be successfully unplugged. When the pressure head is released, the limiting block of the lock body resists against the plug to fix the plug and prevent it from falling, so that connection between an electronic product and a power supply is guaranteed.

The limiting block 8 is made of a rubber material. It can be ensured that the exterior of the plug cannot be damaged by frequent clamping between the limiting block and the plug while a fixing and pretightening force is increased.

The top of the pressure head 21 is of a downwards bent arc shape. This designed structure is matched with a pressing posture of a human hand, and the people's experience of usage is enhanced.

Several heat dissipation holes 13 are formed in side walls of the grooves 3 facing the outer side. Heat of joints between the electronic product and the power supply can be dissipated in time, and the service life of the socket is prolonged.

The bottom of the socket shell 1 is provided with a positioning pillar 14. The socket shell can be fixed on an object or the ground through the positioning pillar, so that the stability of the socket in the usage process is improved.

The sliding plates 10 are obliquely arranged on the two sides of the lock body 22, and the sliding slots 12 are inclined. The inclined sliding plates are slidably connected into the inclined sliding slots. When the pressure head is pressed, the spring deforms, so that the lock body can move back and forth along the sliding slots to realize limitation and releasing of the plug by the limiting block.

The bottom of the limiting convex slot 7 is provided with a clamping slot 15, and a rubber clamping plate 16 is clamped in the clamping slot 15. Damage to the plug due to colliding friction between the bottom of the lock body and the plug is prevented.

The height of the limiting block 8 is greater than the height of the charging plugin 5. A contact area between the limiting block and the plug is enlarged, and the stability of positioning of the plug by the limiting block is improved.

The bottom of the mechanical lock limiting slot 4 is provided with a cross bottom plate 17; the spring 11 is fixedly connected to the cross bottom plate 17; and the bottom of the lock body 22 resists against the cross bottom plate 17.

The working principle: The mechanical lock limiting slots and the grooves are formed in the socket shell; the charging plugins are arranged in the grooves; an accommodating space between the charging plugins and the grooves is used to accommodate plugs; the sliding slots are formed in the mechanical lock limiting slots; the sliding blocks on the lock bodies are slidably connected into the sliding slots; the bottoms of the lock bodies are provided with springs; and the lock bodies can move back and forth by pressing the pressure heads. When the pressure head is pressed, the lock body moves backwards, and the limiting block releases fixing of the plug, so that the plug can be successfully unplugged. When the pressure head is released, the limiting block of the lock body resists against the plug to fix the plug and prevent it from falling, so that connection between an electronic product and a power supply is guaranteed.

The above descriptions are only specific preferred implementation modes of the present invention, but the scope of protection of the present invention is not limited thereto. For any person skilled in the art, within the technical scope disclosed by the present invention, equivalent substitutions or changes made according to the technical solution of the present invention and an inventive idea of the present invention shall all fall within the scope of protection of the present invention.

What is claimed is:

1. A mechanical self-locking type anti-falling socket structure, comprising a socket shell (1) and several mechanical lock mechanisms (2), wherein several grooves (3) and mechanical lock limiting slots (4) are formed in the socket shell (1); a charging plugin (5) is arranged in each groove (3); a charging jack (6) is formed in the charging plugin (5); each mechanical lock mechanism (2) comprises a pressure head (21) and a lock body (22); the lock body (22) outwards extends to be provided with a limiting convex slot (7); a limiting block (8) is clamped in the limiting convex slot (7); the bottom of the lock body (22) is provided with a spring slot (9); two sides of the lock body (22) are provided with sliding plates (10); the bottom of each mechanical lock limiting slot (4) is provided with a spring (11); two sides of a wall of the mechanical lock limiting slot (4) are provided with sliding slots (12); the spring (11) is clamped in the spring slot (9); and the sliding plates (10) are slidably connected into the sliding slots (12).

2. The mechanical self-locking type anti-falling socket structure according to claim 1, wherein the limiting block (8) is made of a rubber material.

3. The mechanical self-locking type anti-falling socket structure according to claim 1, wherein the top of the pressure head (21) is of a downwards bent arc shape.

4. The mechanical self-locking type anti-falling socket structure according to claim 1, wherein several heat dissipation holes (13) are formed in side walls of the grooves (3) facing the outer side.

5. The mechanical self-locking type anti-falling socket structure according to claim 1, wherein the bottom of the socket shell (1) is provided with a positioning pillar (14).

6. The mechanical self-locking type anti-falling socket structure according to claim 1, wherein the sliding plates (10) are obliquely arranged on the two sides of the lock body (22), and the sliding slots (12) are inclined.

7. The mechanical self-locking type anti-falling socket structure according to claim 1, wherein the bottom of the limiting convex slot (7) is provided with a clamping slot (15), and a rubber clamping plate (16) is clamped in the clamping slot (15).

8. The mechanical self-locking type anti-falling socket structure according to claim 1, wherein the height of the limiting block (8) is greater than the height of the charging plugin (5).

9. The mechanical self-locking type anti-falling socket structure according to claim 1, wherein the bottom of the mechanical lock limiting slot (4) is provided with a cross bottom plate (17); the spring (11) is fixedly connected to the cross bottom plate (17); and the bottom of the lock body (22) resists against the cross bottom plate (17).
